(19) United States
(12) Patent Application Publication
(10) Pub. No.: US 2020/0188216 A1
(43) Pub. Date: Jun. 18, 2020

(54) Portable Light Weight Apparatus

(71) Applicant: David J. Hart, Simi Valley, CA (US)

(72) Inventor: David J. Hart, Simi Valley, CA (US)

(21) Appl. No.: 16/221,887

(22) Filed: Dec. 17, 2018

(51) Int. Cl. A61H 3/02; A45B 7/00

(52) U.S. Cl. CPC A61H 3/02; A45B 9/04; A45B 7/00

(57) ABSTRACT

A portable light weight apparatus (“PLWA”) that allows a user with limited mobility to accomplish tasks such as repairs and inspections around and under the house, RV, boat or vehicle that are difficult for a user with mobility limitations to do without the apparatus, beginning with a first side that is adjustable of approximately 6 to 12 inches from a floor surface, a second side that is adjustable of approximately 12 to 18 inches from a floor surface, a third side that is adjustable of approximately 18 to 28 inches from a floor surface, and comprised of handrails on the surface of the apparatus, making it easy for a user to grip anywhere on the apparatus for easy gripping for the user to either raise themselves up from the floor or lower themselves to the floor, utilizing one of the apparatuses sides at a time, by turning the apparatus over to one of its multiple sides of varying length from the floor.

An apparatus that allows a user with limited mobility to accomplish tasks such as repairs and inspections around and under the house, RV, boat or vehicle that are difficult for a user with mobility limitations to do without the apparatus, beginning with a first side that is adjustable of approximately 6 to 12 inches from a floor surface, a second side that is adjustable of approximately 12 to 18 inches from a floor surface, a third side that is adjustable of approximately 18 to 28 inches from a floor surface, and comprised of handrails on the surface of the apparatus, making it easy for a user to grip anywhere on the apparatus for easy gripping for the user to either raise themselves up from the floor or lower themselves to the floor, utilizing one of the apparatuses sides at a time, by turning the apparatus over to one of its multiple sides of varying length from the floor.

### CROSS-REFERENCES TO RELATED APPLICATIONS

| | | |
|---|---|---|
| 10,292,884 | May 2019 | Silverstein et al. |
| 2,817,387 | December 1957 | Blake |
| 3,142,355 | July 1964 | Danielson |
| 5,381,873 | January 1995 | Kniefel et al. |
| 5,692,455 | Dec. 1, 1997 | Winer |
| 6,571,915 | June 2003 | de la Tour |
| 6,719,094 | April 2004 | de la Tour |
| 7,814,708 | October 2010 | Rivera et al. |
| 2008/0029342 | February 2008 | Genova |
| 8,393,684 | March 2013 | Peraza |

### BACKGROUND

### Field of the Invention

The apparatus described generally relates to personal dignity and methods for enabling a user to raise himself up from the floor or lower himself to the floor, using the PLWA.

### Background Art

What differentiates this apparatus from prior art is that a user can travel with it due to its light design, or take it with him or her around the house or on a road trip, in which it can be used to help a user raise him- or herself to a standing position from the floor surface or vice versa. There are two main characteristics of this apparatus, which is that (1) it's made of sturdy and light-weight material in which it is portable in nature and (2) each one of the multiple sides of the apparatus has a different length in which a user can raise himself to a standing position from the floor surface or vice versa by reversing the order of apparatus by rotating it on its sides in decreasing length.

The apparatus is ideal for around the house activities, such as lowering oneself to search under a bed, sink or vehicle and then using it to stand back up again, or an extracurricular activity such as camping, fishing or boating. The apparatus is light enough to carry anywhere.

The most important distinction of the PLWA from any prior art is that it is designed to have all of its sides utilized on the floor surface, depending on the leverage the user is trying to get from the apparatus.

### BRIEF SUMMARY

Elderly individuals with limited mobility that used to enjoy do-it-yourself projects and working around the house, RV, boat or vehicle that have trouble lowering themselves to the floor and then standing up again, are dissuaded from continuing to do projects because of their limited mobility. In many circumstances, users find it easy to lower themselves to the floor where the tricky part is getting back up again. This is all too common with senior citizens. Such situations not only take away a person's dignity, but may also pose a risk to an individual attempting to work around the house in which that individual may seriously hurt themselves and/or hurt those coming to the aid of the individual trying to help the person get up.

### BRIEF DESCRIPTION OF SEVERAL VIEWS OF THE DRAWINGS

FIG. 1 is a perspective view of the first side of the apparatus illustrating the approximate length of the elevation from a floor surface;

FIG. 2 is a perspective view of the second side of the apparatus illustrating the approximate length of the elevation from a floor surface;

FIG. 3 is a perspective view of the third side of the apparatus illustrating the approximate length of the elevation from a floor surface.

### DETAILED DESCRIPTION

The PLWA is made for a user, such as an elderly individual, with limited mobility who used to enjoy do-it-yourself projects and working around the house, RV, boat or vehicle, but now has difficulty lowering themselves to the floor surface and/or raising themselves to a standing position. In many circumstances, users find it easy to lower themselves to the floor surface. However, the tricky part is getting back up again. This is all too common with senior citizens. Such situations not only take away a person's dignity, but may also pose a risk to an individual attempting to work around the house in which that individual may seriously hurt themselves and/or hurt those coming to the aid of the individual trying to help the person get up.

The PLWA has rubber contact points 106 and 111 that are replaceable. The PLWA has many handrails 102, 103, 104, 105, 107, 108, 109, 110, 202, 203, 302, and 303, on each of its sides that are light weight in design.

Regarding the adjustability of the PLWA, it can be purchased in different sizes, making it adjustable to a particular user's height.

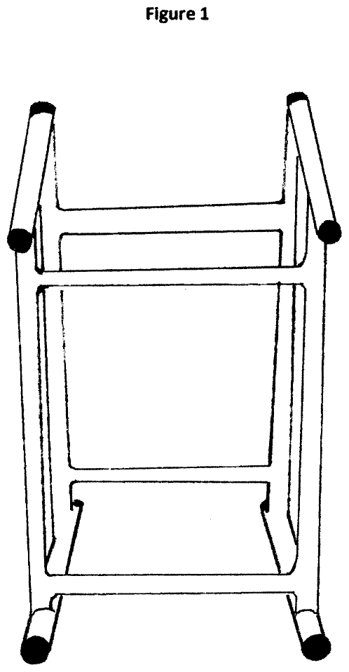

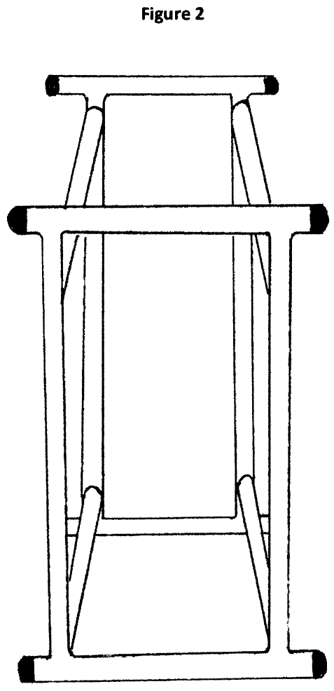

The PLWA has 3 sides of differing length that can help the user raise himself from the floor. Referring particularly to FIG. 1 of the accompanying drawings, the PLWA's first side 100 is placed on a floor surface. If the user is trying to get up from the floor surface, the user will place the PLWA onto its first side 100, with approximately 6-12 inches from the floor surface. The endpoint rubber contact points 111 will come in contact with the floor surface. The user may grip the PLWA's handrails 107 and 109 from 112 and push himself off the floor surface to attempt to get his dominant knee on the floor surface. The user will then push against the PLWA's handrails, particularly 109, to get his other knee to firmly rest on the floor surface. Or, if the user wishes, the user can climb up the PLWA from the indented side 113 which may provide more stability, where the user will grip the PLWA's handrails 104 and 105. The PLWA can also be utilized from the opposite sides mentioned above; where the user can grip the PLWA's handrails from 108 and 110, or from the indented side of 102 and 103.

Once the user has both knees firmly resting on the floor surface, the user will then turn the PLWA onto its second side 200 that is approximately 12-18 inches 201 from the floor surface. With the PLWA facing the user 204, the user will push up from the PLWA's handrail 202 to get his dominant foot to rest against the floor surface. Once his dominant foot is firmly established on the floor, the user will push up against the PLWA's handrail 202 to get his other foot to rest on the floor surface. The PLWA can also be utilized from the opposite side 205; where the user can grip the PLWA's handrail 203.

Once both feet are firmly established on the floor surface, the user will then turn the PLWA onto its third side 300 that is approximately 18-28 inches 301 in length from the floor surface. With the PLWA facing the user 304, the user will push up from the PLWA's handrail 302 to straighten his body to a standing position. The PLWA can also be utilized from the opposite side 305; where the user can grip the PLWA's handrail 303.

The user can reverse the steps to lower himself to the floor.

1. A portable light weight apparatus (PLWA) comprising:
a first side when it is placed on a floor surface, configured to be elevated approximately 6 to 12 inches from the floor surface;
a second side when it is placed on the floor surface, configured to be elevated approximately 12 to 18 inches from the floor surface; and
a third side when it is placed on the floor surface, configured to be elevated approximately 18 to 28 inches from the floor surface.

2. The PLWA of claim 1, further comprising:
on each side of the apparatus to support a user's weight when the user is raising or lowering himself using the apparatus.

3. The PLWA of claim 1, further comprising:
light weight handrails in the composite form resembling PVC piping in which a user can grip anywhere on the apparatus to assist in raising or lowering himself from or to the floor surface.

4. The PLWA of claim 1, further comprising:
the apparatus comprises at least one of a PVC piping composition, aluminum, plastic, and rubber.

5. The PLWA of claim 1, further comprising:
having replaceable rubber contact points for maximum grip to the floor surface.

6. A method of use of a portable light weight apparatus (PLWA), comprising:
placing the apparatus on a first side that is parallel with a floor surface that will provide a user with approximately 6-12 inches in length from the floor surface to help the user raise himself from the floor surface;
turning the apparatus to a second side that is parallel with the floor surface that will provide the user with approximately 12-18 inches in length from the floor surface to help the user raise himself closer to a standing position from the floor surface, where the user can use his dominant foot to push off of while the other leg is resting on its knee;
turning the apparatus to a third side that is parallel with the floor surface that will provide the user with approximately 18-28 inches in length from the floor surface to help the user raise himself to a fully standing position from the floor surface.

7. The method of claim 6, further comprising:
adjusting sides 1, 2, and/or 3 of the apparatus to accommodate the desired length of each side of the apparatus before or during the method of use by the user.
